(19) United States
(12) Patent Application Publication
(10) Pub. No.: US 2026/0105855 A1
(43) Pub. Date: Apr. 16, 2026

(54) IoT-Integrated Hand-Held Cutting Tool and Skill Training Feedback System

(71) Applicant: Rodney Tyrell Knight, Fort Lauderdale, FL (US)

(72) Inventor: Rodney Tyrell Knight, Fort Lauderdale, FL (US)

(21) Appl. No.: 18/915,411

(22) Filed: Oct. 15, 2024

(51) Int. Cl. G09B 5/02; G16Y 10/55

(52) U.S. Cl. CPC G09B 5/02; G16Y 10/55

(57) ABSTRACT

The present invention relates to an IoT-based handheld cutting tool that provides an advanced training system for vocational and technical skill development. It integrates real-time data analytics, sensor technology, and augmented reality (AR) to deliver adaptive feedback. The system captures detailed performance metrics through multiple sensors, while AR visual guidance and wearable technology ensure comprehensive, real-time feedback. This training approach aims to significantly improve psychomotor skills, promote safety, and enhance overall training efficiency for users.

### CROSS-REFERENCE TO RELATED APPLICATIONS

This application relates to the provisional application: U.S. Patent Application Ser. No. 63/590,777, entitled “Food Preparation Device with Embedded Sensors”, filed on Oct. 16, 2023, which is hereby incorporated by reference in its entirety.

### PRIOR ART

U.S. Pat. No. 10,386,888 (Berardinelli):

This patent describes a smartwatch with features for displaying messages and tasks using sensors. It lacks the integration of real-time skill-based feedback for IoT-enabled cutting tools, which is a fundamental feature of the presented system aimed at enhancing user performance and safety.

OmniRing Research Paper (Zhou et al., 2023):

This paper introduces OmniRing, a smart ring for motion analytics. While it uses embedded sensors for monitoring, it lacks the real-time augmented reality guidance needed for effective training and skill enhancement, which distinguishes the presented IoT-enabled cutting tool system.

U.S. Patent Application No. US20170220763A1 (Toupin al. [symbol] al.):

This patent application discusses secure communication through a mobile app. While it involves data collection, it does not support real-time performance feedback or training, which are essential features in the presented IoT-enabled training system.

U.S. Pat. No. 10,399,197 (Chen et al.):

This patent describes using sensors for confirming the location of a cutting tool. While it tracks tool positioning, it lacks integrated augmented reality and dynamic performance feedback, both of which are crucial to the presented training system for user guidance and skill improvement.

Japanese Patent No. JP2012053074A (Cooking Skill Determination System):

This patent involves determining cooking skills using movement data from a kitchen knife. Although it provides basic feedback, it lacks real-time AR-guided corrective feedback and adaptive learning mechanisms, which are core components of the presented system for effective skill enhancement.

Chinese Patent No. CN106113096A (Intelligent Kitchen Knife):

This patent discloses a kitchen knife with sensors for gravity, acceleration, and communication. While it features basic guidance, it lacks augmented reality for immersive skill training and real-time performance evaluation, which are key features of the presented training tool.

“The French Kitchen: Task-Based Learning in an Instrumented Kitchen” by Hooper et al. (2012):

This publication describes an instrumented kitchen used for language learning. It incorporates technology for interaction but does not feature dynamic, real-time adaptation or personalized skill-based training feedback, both of which are integral to the presented system.

“The Assistive Kitchen—A Demonstration Scenario for Cognitive Technical Systems” by Beetz et al. (2008):

This paper presents a cognitive system for assisting with household chores. Although it aligns with providing user guidance, it does not incorporate sensor-driven data collection or adaptive, real-time feedback, which are critical for skill development in the presented training system.

U.S. Patent Application No. US20200215705A1 (Glesser et al.):

This patent describes a knife with an integral sealed power source and additional electronic features. However, it lacks IoT-enabled sensor integration for capturing detailed movement data and providing adaptive performance feedback, which are essential elements of the training system being presented.

European Patent No. EP4095777A1 (Martinez y Gascon, S.A.):

This patent involves monitoring hand tools with wearable devices and passive transponders. While it tracks tool use, it lacks the real-time dynamic feedback mechanism crucial for guiding users during training and improving skills, a core aspect of the presented IoT-enabled cutting tool training system.

European Patent No. EP2043826A1 (Friedr Dick GmbH and Co KG):

This patent discloses a knife with an embedded transponder for identification and tracking. Although the method aims to minimize electromagnetic interference, it lacks real-time sensor-based data capture and analysis for performance feedback, which are critical features of the presented IoT-enabled training system to enhance user skill and efficiency.

### BACKGROUND OF THE INVENTION

With over 12 million students currently enrolled in Career and Technical Education (CTE) programs across the United States, these programs play a vital role in equipping individuals with the technical skills of the modern workforce. However, despite their critical importance, many environments rely on methods that fail to provide the dynamic, real time feedback. Recent technological advancements, including IoT devices, augmented reality (AR), and machine learning algorithms, present significant opportunities to enhance vocational training. These innovations can help bridge the gap between traditional training systems and the demands of a technology-driven economy. Unfortunately, many of these tools are deployed in isolation, without a cohesive system that fully integrates real-time data, feedback, and user interaction. The proposed solution addresses this by combining IoT-enabled tools, AR glasses, and video capture devices into a single, cohesive platform. By incorporating real-time analytics and biomechanical data, this system offers personalized, adaptive feedback that helps students refine their psychomotor skills while ensuring safety and operational efficiency. Through this integration of advanced technologies, the system not only modernizes vocational training but also aligns it with the evolving needs of the workforce. This approach ensures that learners are better prepared for careers in skilled labor by enhancing their training with data driven actionable insights, adaptability, and targeted instruction.

### SUMMARY OF THE INVENTION

The present disclosure relates to an invention comprising an IoT-enabled hand-held cutting tool and a system for displaying aggregated performance data. The IoT-enabled hand-held cutting tool is equipped with sensors to capture user performance metrics during training sessions. The data collected from the IoT-enabled hand-held cutting tool is processed and integrated into a comprehensive system that provides a display of aggregated metrics, real-time feedback, and system-generated recommendations.

In one embodiment, the process includes capturing detailed motion data through sensors embedded on a handheld cutting tool, wherein the sensors monitor multiple aspects of user movements. The aspects of user movements may include, for example, speed, accuracy, and force.

In one embodiment, methods include transmitting captured data to a central processing unit, which processes and organizes the performance metrics into a display that represents various movement parameters. Each movement parameter provides an aggregated representation of the user's performance over the duration of the training session. Upon detecting user input selecting a specific movement parameter, the system generates an expanded view, wherein the expanded view provides detailed insights into the selected parameter, including visual feedback and system-generated recommendations for improvement, based on an analysis of the captured metrics.

In another embodiment, the use of a battery allows for greater flexibility in various training environments, enabling users to operate the tool without the limitations of wired power sources. The use of a battery allows for greater flexibility in various training environments, enabling users to operate the tool without the limitations of wired power sources.

In another embodiment, the system includes wireless capabilities for transmitting performance data to a processing unit.

In one embodiment, a camera is equipped with wireless data transfer functionality, allowing performance data to be transmitted directly to a processing unit. The camera captures and transmits detailed visual information regarding user activities, utilizing wireless protocols such as Wi-Fi or Bluetooth. The processing unit, upon receipt of the visual data, may integrate it with sensor data to perform a comprehensive evaluation of user performance. It should be appreciated that the wireless data transfer enhances system flexibility and facilitates seamless performance monitoring.

In one embodiment, the IoT sensor module is both detachable and interchangeable, providing flexibility for different training setups.

In another embodiment, the process includes displaying, on a device, multiple parameters that represent different performance metrics, wherein the performance metrics include, for instance, accuracy, speed, and force applied during training using the IoT-enabled tool. Upon detecting a change in the user's performance or the orientation of the tool, the system can automatically identify and select a subset of the displayed parameters that are most relevant to the detected change. The system then provides detailed feedback on the selected parameters, wherein the feedback is adjusted to reflect the user's current technique and is presented to the user through display interfaces.

In another embodiment, an AR interface may be configured to provide contextual information relevant to the user's activity, such as optimal hand positioning or target movement patterns.

In another embodiment, the process can include generating, on a device, a display that presents multiple parameters associated with the performance metrics of each user. Upon receiving an input request to view another user's performance data, the system can switch the display to present the performance metrics corresponding to the selected user. This functionality enables instructors or authorized users to compare the performance metrics of multiple trainees, thereby providing detailed insights into individual progress and facilitating comparative assessments to evaluate improvement across participants.

In another embodiment, the process includes generating a display of performance data for multiple team members during collaborative training. The system presents various parameters associated with each member's performance, such as speed, accuracy, and tool pressure. Upon receiving a request to view a specific team member's data, the system can switch the display to show detailed metrics for that selected individual. This functionality allows instructors or authorized users to compare the performance metrics of multiple participants, providing detailed insights into each member's progress and enabling comparisons to assess improvement and foster collaborative feedback. Additionally, the system can notify team members when their data is shared to facilitate peer assessment and encourage transparent, collaborative learning.

In another embodiment, the process includes displaying a graph on a device that compares multiple sets of training data, each corresponding to different performance metrics. For instance, one data set could represent the user's movement speed, while another tracks accuracy over time. Upon detecting user interaction with the graph, the system highlights the selected data set, offering a detailed breakdown of the associated metric. The system can also dynamically modify the graph in real-time to reflect changes in performance as additional data is collected during the training session.

In another embodiment, the graph could plot metrics such as force exerted and consistency over multiple sessions. When a user interacts with a specific point on the graph, the system highlights the relevant data and provides further analysis of the selected metric. The graph adjusts continuously during live training, reflecting ongoing performance changes, and offering real-time feedback based on user input or system monitoring.

In another embodiment, the system could display an aggregated overview of team performance metrics over multiple sessions. When a user selects a specific team member, the system highlights the relevant metrics and provides further analysis of that individual's performance. The display adjusts continuously during live training, reflecting ongoing changes in team metrics and offering real-time insights based on user interactions or system monitoring, ensuring users remain actively engaged in their progress.

In another embodiment, the process involves collecting data from a variety of validated inputs, such as electronic devices or software systems intended to capture user-related performance metrics.

In some examples, the process involves the transmission of collected data to a variety of validated endpoints comprising of electronic devices or software applications.

The system further includes devices and non-transitory computer-readable media configured to implement these methods.

### BRIEF DESCRIPTION OF DRAWINGS

The flowchart represents the procedural workflow involved in the initiation and execution of the training process. The initiation step includes the user selecting a training mode and picking up an IoT-enabled handheld tool, where sensors and cameras are employed to capture movement data for analysis.

The flowchart demonstrates feedback loops and the module selection process, where the user is presented with visual performance metrics on either a digital display or an augmented reality interface, allowing for real-time feedback. The user subsequently reviews system-generated recommendations and selects an appropriate training module based on analyzed sensor data.

The flowchart also outlines the continuous monitoring of user progress and subsequent adjustments to training sessions. Collected performance metrics are shared with instructors or team members for collaborative assessment, resulting in the integration of external feedback into future training sessions. Completion of the training process is depicted, where system adjustments are made based on user progress, and training goals are refined. This ensures comprehensive progress tracking and targeted performance improvement, utilizing adaptive training techniques to effectively meet user requirements.

### DETAILED DESCRIPTION OF THE INVENTION

The IoT-enabled handheld cutting tool integrates advanced microcontrollers, motion sensors, and various IoT-enabled components to create a versatile and sophisticated training environment. The system features a suite of embedded sensors, including accelerometers, gyroscopes, and pressure sensors, that capture detailed user movement data during training sessions. These sensors continuously measure metrics such as speed, accuracy, and applied force, transmitting the data in real-time to a central processing unit (CPU) for further analysis.

The central processing unit, which may be embedded in the tool or accessed via a connected tablet or mobile device, processes the movement data to generate comprehensive performance metrics. These metrics are then visualized through a user interface, which can include both digital displays and augmented reality (AR) interfaces. The user interface presents an aggregated view of performance metrics, real-time feedback, and system-generated recommendations to help users refine their skills effectively.

The AR interface provides users with contextual guidance directly in their line of sight, offering step-by-step instructions for optimal hand positioning, movement patterns, and corrective feedback. This AR guidance, combined with a camera system, captures a complete view of the user's workspace, enabling precise analysis of user actions. The camera transmits visual data wirelessly to the CPU, where it is integrated with sensor data to offer a full evaluation of user performance, including precision and adherence to ideal techniques.

The tool may feature detachable IoT sensor module, enhancing adaptability for different training environments. This modularity allows customization for specific applications, extending the functionality of the tool while maintaining ease of use.

The system is equipped with real-time wireless communication capabilities, using technologies such as Wi-Fi or Bluetooth, to transmit performance data to the processing unit. This wireless connectivity enhances user mobility, allowing the tool to be used freely without restrictions imposed by wired connections. Additionally, the handheld tool operates on battery power, providing versatility across different training scenarios without the need for a constant power supply.

The training system provides a visual breakdown of performance metrics, allowing users to interact with specific metrics for a deeper understanding. Users can access an expanded view, offering more detailed insights and tailored recommendations for improvement. This feature helps users identify key areas of focus and guides them in enhancing their techniques through targeted feedback.

The system also includes a feature for dynamically displaying multiple sets of training data, such as speed and accuracy, on a real-time updating graph. This allows for continuous monitoring of progress during training. Furthermore, team members or instructors can be notified when user data is shared, facilitating collaborative assessment and ensuring a transparent feedback process.

The central processing unit has the capability to automatically identify performance metrics that are most relevant to changes in user behavior or tool orientation. The system then provides adaptive, real-time feedback that evolves with the user's skill level, helping to foster continuous improvement.

For multi-user training scenarios, the system aggregates performance data from multiple handheld cutting tools, allowing instructors to compare individual metrics between trainees. This capability enables instructors to offer customized feedback for each user, encouraging skill development through comparative assessments and collaborative learning.

The IoT-enabled handheld cutting tool and its integrated system deliver a highly effective training solution. By utilizing advanced sensors, real-time data analysis, AR-enhanced guidance, and wireless connectivity, the tool offers a personalized and responsive training experience. This comprehensive approach ensures that each user receives feedback tailored to their unique needs, promoting both efficiency and safety throughout the training process.

1. An IoT-enabled handheld cutting tool comprising:
a plurality of sensors embedded in said tool, said sensors configured to capture detailed motion data during user training sessions, wherein said motion data includes speed, accuracy, and force parameters;
a central processing unit configured to receive and process said motion data in real-time, and wherein said central processing unit provides an aggregated representation of said motion data through a user interface.

2. The IoT-enabled handheld cutting tool of claim 1, wherein said user interface provides an expanded view of selected motion parameters, including visual feedback and system-generated recommendations for improvement.

3. The IoT-enabled handheld cutting tool of claim 1, wherein said tool further comprises a battery, allowing said tool to operate wirelessly without the limitations of a wired power source.

4. The IoT-enabled handheld cutting tool of claim 1, wherein said tool further comprises a wireless transmitter configured to transmit performance data to the central processing unit.

5. The IoT-enabled handheld cutting tool of claim 4, wherein said wireless transmitter is configured to utilize wireless communication protocols, including at least one of Wi-Fi or Bluetooth, for transmitting said performance data.

6. The IoT-enabled handheld cutting tool of claim 1, wherein said plurality of sensors includes a camera configured to capture and transmit visual information of user activity to the processing unit.

7. The IoT-enabled handheld cutting tool of claim 6, wherein said processing unit is configured to integrate said visual data with motion data to evaluate user performance.

8. The IoT-enabled handheld cutting tool of claim 1, wherein said tool further comprises a detachable and interchangeable IoT sensor module, providing flexibility for different training setups.

9. A method for evaluating user performance using an IoT-enabled handheld cutting tool, said method comprising:
capturing motion data using a plurality of sensors embedded in said cutting tool, wherein said motion data includes speed, accuracy, and force applied during training;
transmitting said motion data to a central processing unit;
generating a display representing said motion data, wherein said display includes an aggregated view of multiple performance metrics;
detecting user input selecting a specific motion parameter and generating an expanded view of said parameter, including detailed insights and system-generated recommendations.

10. The method of claim 9, wherein said method further comprises providing contextual feedback through an augmented reality interface, wherein said feedback includes guidance on optimal hand positioning and target movement patterns.

11. The method of claim 9, wherein said display further comprises performance data from multiple users, enabling comparative assessments and collaborative feedback among users.

12. The method of claim 9, wherein said display further includes a graph comparing multiple sets of training data, each corresponding to different performance metrics, and wherein said graph is dynamically modified in real-time to reflect changes in performance.

13. A system comprising:
an IoT-enabled handheld cutting tool as described in claim 1;
the central processing unit configured to receive and analyze data from said cutting tool;
the user interface configured to present aggregated performance metrics and provide real-time feedback.

14. A non-transitory computer-readable medium storing instructions for implementing the method of claim 9.
